(19) United States
(12) Patent Application Publication
(10) Pub. No.: US 2006/0029911 A1
(43) Pub. Date: Feb. 9, 2006

(54) Methods and apparatus for buying and selling books

(76) Inventors: David S. Monk, Farmington, UT (US); Mickal K. Winward, American Fork, UT (US)

Correspondence Address: THORPE NORTH & WESTERN, LLP., 8180 SOUTH 700 EAST, SUITE 200, SANDY, UT, 84070, US

(21) Appl. No.: 11/193,255

(22) Filed: Jul. 29, 2005

Related U.S. Application Data
(60) Provisional application No. 60/592,692, filed on Jul. 30, 2004.

(51) Int. Cl. G09B 19/18

(52) U.S. Cl. 434/107

(57) ABSTRACT

A method is provided for conducting a plurality of merchandising transactions with customers of a bookstore relating to a plurality of books. A unique book number is assigned to a selected printed book in the plurality of books, and the book number is affixed to the selected book. The book number is recorded in a database, and linked to indicia related to the book. Then each transaction related to the selected book is recorded in the database together with customer information. Book and label products are provided comprising a printed book and a label affixed to the printed book having a book number thereon that is unique to that printed book. Methods are provided for conducting buying and/or selling transactions with a customer relative to a selected printed book. In addition, a method is provided for conducting buying and selling transactions with a customer relative to a plurality of books involving a network of bookstores including providing in-store credit applicable to transactions in any network bookstore. Also, a method is provided for a bookstore to maintain an accurate on-line database of textbooks required by faculty members of a school.

### CROSS-REFERENCE TO RELATED APPLICATIONS AND CLAIM OF PRIORITY

Priority of U.S. Provisional patent application Ser. No. 60/592,692 filed on Jul. 30, 2004 is claimed.

### BACKGROUND

1. Field of the Invention

The present invention relates generally to buying and selling books. In particular, the present invention relates to methods and apparatus for buying and selling books, including used university textbooks.

2. Background

Today's students, particularly university students, are faced with dramatic increases in the cost of an education. Although college tuition and living expenses have risen substantially in the past few years, textbook prices have increased astronomically. The cost of books for an education has reached crisis levels for many students. College textbooks now routinely cost over $100 to purchase new. In addition, attempts to purchase used books are difficult, because of the meager number of available used books through bookstores, and the prices are still relatively high. Yet, when students try to sell their used books to bookstores, there seems to be little if any value given for the books. The limited buy-back policies of many college bookstores artificially restrict the supply of used books available to students.

In addition, it is sometimes difficult to even purchase desired textbooks at any price. In some cases, lack of real-time coordination between faculty members and college bookstores may result in the wrong books, or incorrect editions, being ordered, or in orders being placed too late for books to be available for a class. It is not unusual for a college bookstore list to be about 30-40% incorrect, compared to real-time book availability and the needs of the faculty. Other problems in receiving the desired books might be caused by publishing or shipping delays or errors.

Some bookstores are not efficiently run, either because of inexperienced employees or lack of motivation because of university politics and policies. These inefficiencies lead to higher prices for student textbooks, even if a university bookstore margin is low. In addition, unrealistic bookstore budgets set by a university with many other pressing needs, might increase problems with inadequate inventories and lack of training and under-staffing of employees.

Moreover, bookstores usually have no system for monitoring books that are bought and sold by a bookstore, particularly in keeping track of damaged books and trying to avoid fraud. For example, a damaged book might be given a certain value when it is bought back from a student. Yet, a bookstore employee might overlook the damage when pricing the book for resale. In addition, since college bookstores typically have no system for tracking its books, bookstore patrons sometimes commit fraud by picking up a used book in the bookstore and selling it to the bookstore, ostensibly as the patron's used book.

Another problem for bookstores is the constant need for cash to build up and maintain book inventories. Usually, bookstores must take out large loans or obtain large lines of credit in order to maintain this inventory. The problem is exacerbated by the bookstore paying cash for used books that may suddenly have no market if a new edition comes out or a faculty member switches to another book or discontinues the course. As a result, a bookstore tends to establish low allotments for the number of used books it will buy for each class. Moreover, to ease the need for cash, a bookstore tends to sell its used books to wholesalers and then later buy them back at a much higher price if the books are later in demand. This places an additional burden on students who are faced with paying inordinately high prices for used books.

Further problems arise for institutional and corporate customers of bookstores. Such entities are usually limited by strict budgets that are difficult to administer while trying to meet all the educational needs of employees of the entities. In addition, it is often difficult to recoup funds from the re-sale of used books to bookstores by employees or clients who may then pocket the money rather than returning the funds to the employer or agency who bought the books.

### SUMMARY OF THE INVENTION

One embodiment of the present invention comprises a method for conducting a plurality of merchandising transactions with customers of a bookstore relating to a plurality of printed books. The method includes assigning a unique book number to a selected printed book in the plurality of printed books, affixing the book number to the selected printed book, recording the book number in a database, linked to indicia related to the printed book, and recording each transaction related to the selected printed book.

Another embodiment of the present invention comprises a book product, including a printed book and a label affixed to the printed book having a book number thereon that is unique to the printed book. In addition, an embodiment of the present invention comprises a book label for affixing to a printed book, the book label having a book number thereon that is unique to the printed book.

Another embodiment of the present invention comprises a method of buying a selected printed used book. The method includes recording certain indicia related to the selected printed used book in a database, electronically searching a plurality of merchandising databases for comparison indicia similar to the indicia of the selected printed used book, determining a price relative to the comparison indicia, determining an optimum price for the selected printed book and a channel for placement of the used book, and assigning a unique book number for the selected printed book.

Another embodiment comprises a method of a bookstore buying a selected printed used book from a customer. The method includes buying the printed used book from the customer, assigning a unique book number to the printed used book, entering the book number in a database of the bookstore, and recording customer information in the database associated with the book number.

Another embodiment comprises a method of a bookstore selling a selected printed book to a customer. The method includes assigning a unique book number to the printed book, entering the book number in a database of the bookstore, selling the printed book to the customer, and recording customer information in the database associated with the book number.

Another embodiment of the present invention comprises a method of conducting buying and selling transactions with a customer relative to a plurality of books involving a network of bookstores. The method comprises recording indicia relative to the customer in a database to create a customer account in any bookstore in the network of bookstores, establishing a credit amount in the account of the customer, providing access to the database having the customer account with the credit amount to all the bookstores in the network of bookstores, and enabling any bookstore in the network of bookstores to directly make changes in the credit amount relative to book transactions by the customer at said any bookstore.

Yet another embodiment comprises a method for a bookstore to maintain an accurate booklist database of textbooks needed for courses taught by faculty members of a school. The method includes entering information into the bookstore booklist database regarding classes to be offered by the school and faculty members associated with each class, enabling on-line access for a faculty member to enter textbook information into the booklist database regarding textbooks required for each class associated with the faculty member, comparing the textbook information against current information about each textbook from on-line textbook sources, providing on-line notification to the faculty member of current availability and other information regarding each textbook, and enabling the faculty member to provide information for updating the booklist database with changes in the textbook information.

### BRIEF DESCRIPTION OF THE DRAWINGS

FIG. 1 is a schematic view of a label, according to one embodiment of the present invention;

FIG. 2 is a schematic view of the label shown in FIG. 1 affixed to a book, according to one embodiment of the present invention;

FIG. 3 is a flow diagram showing a book buy-back process, according to one embodiment of the present invention;

FIG. 4 is a flow diagram showing a book selling process, according to one embodiment of the present invention;

FIG. 5 is a flow diagram showing an in-store credit process within a bookstore network, according to one embodiment of the present invention; and

FIG. 6 is a flow diagram showing an on-line process for a bookstore to maintain an accurate booklist database reflecting the textbooks needed by faculty members of an associated school, according to one embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Previously-known systems have been developed for buying large groups of books, such as the entire book inventory of a school or a class. However, there is a need for better systems to find the best prices for new and used textbooks, to individually track new, used and damaged books, to develop funds for building and maintaining an adequate inventory and for providing accurate on-line college booklists that reflect the expected courses of a school and the needs of the associated faculty.

The present application includes several aspects that are involved with buying and selling new and used books, such as textbooks. In one embodiment the aspects of the present application are primarily based in a software system having the ability to carry out the functions of each of the aspects discussed herein. Other embodiments of the present invention can be hardware based or a combination of hardware and software. The system described herein works in a single bookstore or a network of cooperative or sister bookstores, such as franchises.

One aspect of the systems and methods involves using a unique identifying number (called a BK number) for each new or used printed book that is placed into the buy-sell inventory of the system. As used herein, the terms “printed book” and “book” are used interchangeably to mean a singular object comprising a single printed book, rather than a particular book title that is common for many printed books. The BK number is a unique number for each printed book that is used to track the history of each printed book, reduces fraud and theft, allows for special pricing for damaged books and enhances inventory control. The BK number is different from the ISBN number, since each printed book is given a unique BK number, even though the printed book may be identical with other printed books having the same ISBN number.

Another aspect of the present application is unique software that is used to search a large variety of internet-based and wholesale databases, in order to locate the best price for used books to be sold to purchasers, as well as to find the best places to sell used books in order to be able to pay students the very best used-book prices for their books.

Another aspect of the present application is the use of In Store Credit (ISC) throughout a network of bookstores. The ISC system enables individuals to sell used books to a store in the network, thereby accruing in-store credit, which can be used at any other store in the network. In addition, the ISC system enables public and private entities that buy textbooks for their employees to save money and increase control on book spending practices. Thus, an entity that has a specific annual budget for textbooks can use the ISC system to limit the amount of credit allotted to employees or clients for textbooks. Furthermore, when used books are sold back to a store using the ISC system, a credit is given to the entity account, rather than giving the employee money for the book that was purchased with entity funds.

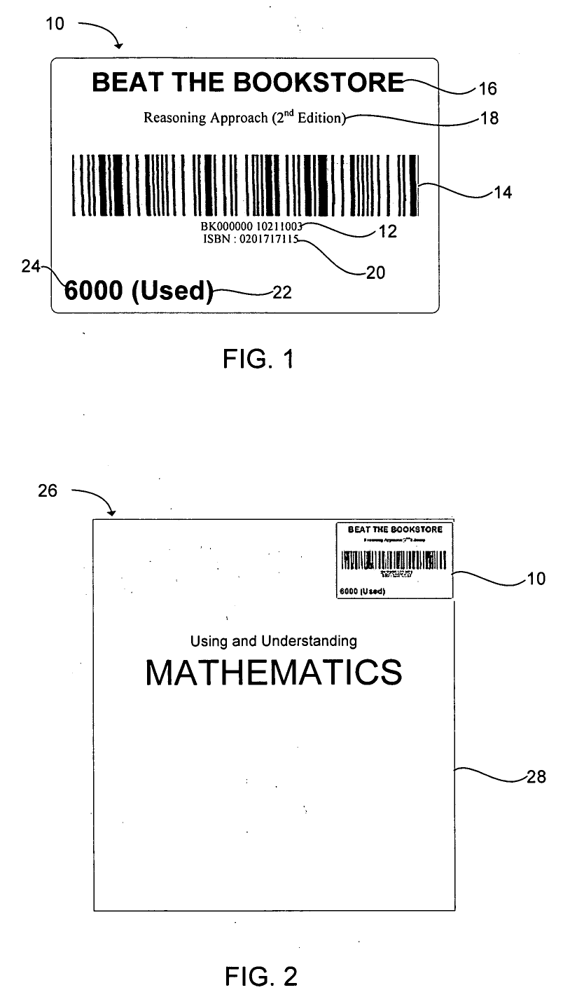

Another aspect of the present application is the use of real time on-line coordination with faculty members of a school associated with a bookstore, in order to compile a booklist that is accurate and reflects the availability of books needed for school classes and special needs or requests by university faculty. This approach enables a bookstore to place accurate and timely orders, so that the right books are available when needed. FIG. 1 shows a label 10 for affixing to a printed book according to one embodiment of the present invention. The label includes the BK Number 12, which in this example is “BK00000010211003.” The BK Number 12 is also included in a bar code form 14 that can be electronically scanned by an appropriate reader (not shown). Other indicia on label 10 include the name 16 of the bookstore that originated the label, which in this case is “Beat The Bookstore,” a short-hand identifier 18 of the book title and edition, and the ISBN number 20. Another identifier 22 is included to indicate the status of the book, such as being a used book. A channel identifier code 24 indicates the channel or buyer that is willing to pay the most for the used book.

The BK Number 12 is assigned by the bookstore or by any affiliated bookstore in a network of bookstores at the time of the first transaction with each book. Unlike the ISBN that is unique only for a particular book title and edition, the BK Number 12 is unique to each specific printed book.

Looking at FIG. 2, label 10 may be affixed to a printed book 26 such as on the back cover 28, as shown. Preferably, the label 10 is disposed in a readily available location for electronic scanning. Label 10 should also be placed in a position on the book where it will not cover up text or numbers, as shown. The BK Number 12 enables a bookstore to track the history of each printed book 26 and to know its present status. Thus, the bookstore is immediately aware of whether the customer bought the book at the bookstore and, if so, how much was paid and when it was bought. The bookstore can also determine the current status of the book. In the unusual event that the customer is attempting to defraud the bookstore by trying to sell a used book that is on sale in the bookstore, the status is immediately determined and the fraud can be revealed. If there is any damage in the history of the book, it will immediately be indicated to the bookstore clerk.

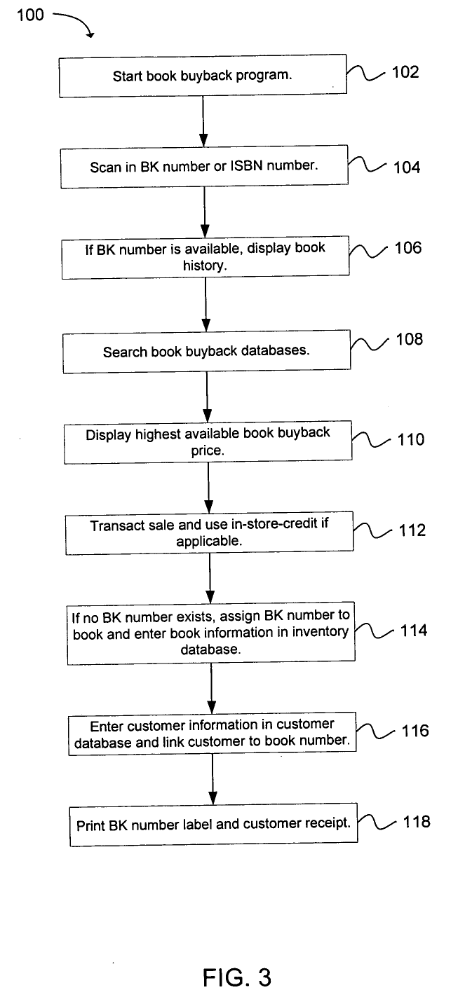

Referring now to FIG. 3, an algorithm is shown for a method 100 involved in buying back a used book, beginning at step 102. The object of the process shown in FIG. 3 is to search a substantial number of wholesaler databases and internet seller databases to ensure that a student receives a good price for his/her book and the bookstore is able to sell the book to a channel offering the highest price.

At step 104, the used book is scanned for a unique book number (BK Number), if there is one, so that any prior history of the book in the network of bookstores is found, including its ISBN number. If the book does not have a BK Number, its ISBN number is scanned. At step 106, if a BK Number is found, the history of the book is displayed or printed for the sales clerk. This information provides the clerk with valuable information that is useful in determining a book buy-back price, as well as to educate the customer about why a book maintains a certain value.

Next, at step 108, a search is conducted of databases to determine the best buy-back price for the book. In one embodiment, the databases can be internet-based or stored on a CD, tape, or other electronic storage device that are stored in the local database of the bookstore. The databases may include the following: on-site bookstore booklist, college textbook wholesaler's guide, K-12 textbook wholesaler's guide, internet booksellers, and the booklists for the schools where other bookstore affiliates are located.

In some instances, it may be important to search further for more information in order to determine the best price for the book. For example, one may want to determine the edition number of the book, the year of publication, the author, the publisher, old edition information, and imminent future editions, as well as other information that may be important in a given situation. A determination can also be made as to what channel to assign the book. For example, if there is likely to be a need in the near future for the used book, it can be retained in the bookstore and not sold to the wholesalers. This approach can enable the bookstore to resell the used book later for a lower price to students by eliminating the high turn-around cost of selling a used book to a wholesaler and then buying it back later at a much increased price.

In the event that the used book is not expected to be used in the near future, then the market value is substantially less, and the bookstore will likely sell the book to a wholesaler.

Once the highest book buy-back price is determined, it is displayed to the clerk and possibly to the customer, at step 110. If the customer agrees with the price, the sale is transacted, at step 112, usually by cash or check. Alternatively, the customer may be paid in “In Store Credit” (ISC) for use in purchasing the next book or other merchandise from the bookstore. In the event that the bookstore is in a network of bookstores, the ISC account of the customer may be honored by any of the other affiliated bookstores.

Similarly, an institution or company may purchase an ISC account with its allotted budget, so that employees or clients may use the account to obtain books without needing to pay first for the books and then get a reimbursement from the employer. In addition, when the customer is ready to sell the book back to one of the bookstores in the network, the sale price may be credited to the ISC account for the company that purchased the book. Thus, at the time of book purchase by the customer, the need to use cash and be reimbursed by the company or agency can be omitted. At the time that the used book is sold back to the bookstore, the buy-back funds can be sent to the company or agency for re-use in its budgeted ISC account, rather than to the pocket of the employee.

At step 114, if the book has no BK Number, a number can be assigned to the book and a label can be affixed to the book. Then at step 116, the customer information can be entered into the database. This information becomes associated with the BK Number, so that when that number is scanned, the customer information is automatically retrieved. In addition, the book information can also be entered into the inventory database associated with the BK Number, so that when that number is subsequently scanned, the book information is automatically retrieved.

Finally, at step 118, a label with the BK Number thereon is printed and affixed to the book. Even if a label with the BK Number is already applied to the book, a new label is printed and affixed to the book, in order to provide a fresh, clean label and to update any information about the book. Any of several conventional systems and labels may be used to print and affix a suitable label to the book. Preferably, the label with the BK Number is affixed in a secure manner that cannot be easily removed or tampered with. The label may be affixed to the outside of the book or at a designated page inside. At the same time, customer information such as a receipt and a customer information record may be printed out.

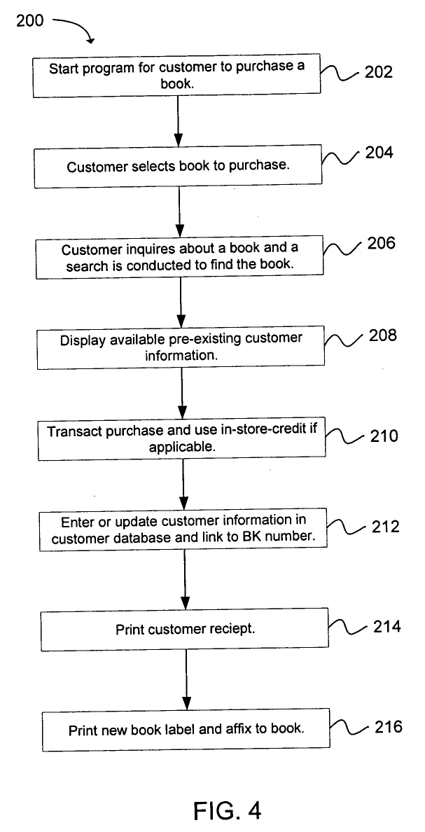

Referring next to FIG. 4, a book selling process 200 is shown. This process is involved with the situation where a student or other buyer desires to purchase a used or new book from the bookstore, beginning with start at 202.

At step 204, a customer selects a book from a shelf of the bookstore for purchase. Alternately, at step 206, the customer may ask about a book that the customer desires to purchase, and a search is conducted to determine where copies of the book are located. If the book is in the bookstore's inventory, the price of new and used books in the inventory is provided for the purchaser to make a decision. If the book is not in the stock, a search is conducted of the inventories of all the bookstores in the network, beginning with the closest bookstores and branching outward. If the book is found at a suitable price in the inventory of one of the bookstores in the network, arrangements are made to purchase the book at the bookstore and have it shipped to the customer or to the selling bookstore, as desired.

Next, at step 208, any pre-existing customer information is retrieved from the customer database. This information can provide a history of prior dealings with the customer and can indicate the status of the customer's ISC status. At step 210, if the purchase price is acceptable, a purchase transaction is conducted, either through cash, check, debit, or credit card, or using in-store credits (ISC) of the customer, if any are available. All books sold to customers by the bookstore will have a BK Number and a label, as discussed in connection with FIGS. 1 and 2, specifically identifying the printed book. Next at step 212, a customer database is set up or, if one exists, any new customer information is entered into the customer database, and linked to the BK Number of the printed book being purchased. Finally, at step 214, the customer receipt is printed to provide a record of the transaction for the customer. At step 216, if desired, a new label with the BK Number may be printed and affixed to the printed book, either because the current label has been defaced or because the label needs to be updated.

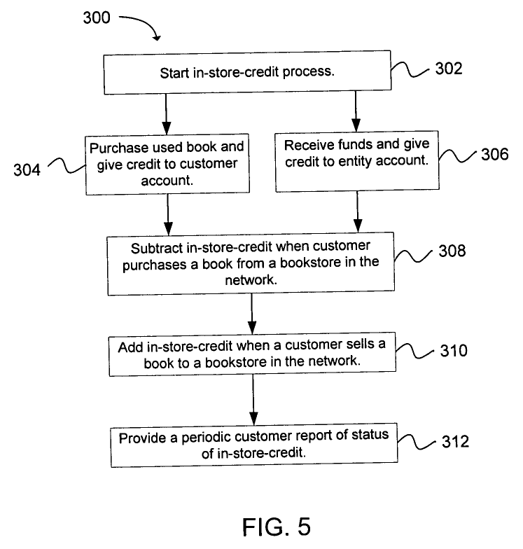

Referring next to FIG. 5, a process 300 is shown whereby customers are provided with in-store credit when buying books from or selling books to a bookstore that either stands alone or is part of a network of bookstores. The process may start at 302 in one of two ways. First, at step 304, the bookstore may purchase a used book from a customer. Rather than paying the customer cash, the bookstore provides in-store credit for the customer in the bookstore or the bookstore network. The in-store credit arrangement provides a number of advantages. First, the bookstore avoids the need for funds to pay the customers. This approach enables a bookstore to build up a substantial inventory of used books without needing to find capitalization funds. In addition, the student has credit when needed to purchase additional books for new classes.

Alternately, at step 306, the customer may be an entity having a need to set up credit for its employees, clients and others affiliated with the entity to purchase textbooks directly. This approach provides a ready market for the bookstore, since the employees and clients will need to shop at the bookstore to obtain access to the funds deposited by the entity. In addition, this approach is advantageous to both the customers and the entity, since there is no need for a customer to purchase a book and then go through the process of obtaining reimbursement for the process. In addition, the entity can be sent a report of all such purchases, confirming that such purchases were made and avoiding the possibility of fraud.

Next, at step 308, a customer may enter any bookstore in the network, purchase any desired textbooks, and charge the amounts directly against credit provided to him or to an entity previously credited with advance payment. The entity may also provide instructions with its account regarding the names of authorized book purchasers, the authorized amounts that can be purchased and other information necessary for the entity to exert control over the expenditure of funds in the customer account.

At step 310, a customer may have a used book to sell back to the bookstore. The funds from the sale of the book can be credited to the customer or to the entity's account for future use in the purchase of more books. This approach avoids the temptation of the customer who purchased under credit from an entity to sell the used book to the bookstore and pocket the money. It also encourages the individual customer to build up individual credit that can be applied against future purchases. Optionally, at step 312, periodic reports may be sent to a customer or an entity of the status of the in-store credits and the history of transactions over a selected period of time.

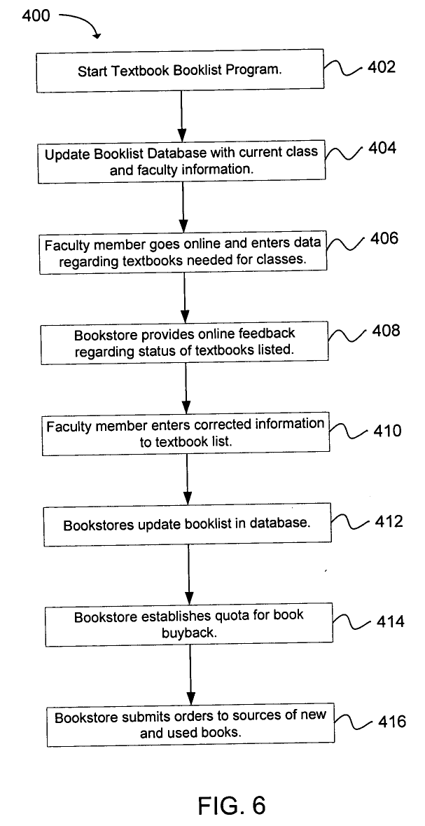

With reference to FIG. 6, an on-line real-time process 400 is shown for creating and maintaining an accurate system, referred to as the Adoption Request System, that reflects the booklist for associated college courses and the current faculty textbook needs. Starting at step 402, it is presumed that faculty members have previously been contacted about the process and given a password to enter an on-line system. At step 404 the bookstore updates its system database with current information about the school classes and faculty. Then, at step 406, a faculty member may enter the on-line system and supply information, including ISBN numbers, for the textbooks he intends to use in connection with courses to be taught in the next semester.

Next, at step 408, the bookstore can provide on-line feedback with information to the faculty member regarding the status of the books he has listed. For example, the book may be out of print, the edition being ordered may be outdated, the title or author information may be incorrect or any number of other errors may occur. Then, if necessary, at step 410, the faculty member can provide further on-line data correcting the descriptions of the books needed or asking for more information. This step enables the bookstore to enter the updated booklist data, at step 412, in order to maintain an accurate booklist of the needs of each faculty member prior to any orders being sent to a publisher or wholesaler. Subsequently, at step 414, the bookstore can establish realistic quotas for the types and amounts of used books to be purchased from students for each course. At step 416, the bookstore may also submit book orders to a publisher, wholesaler or other source for new or used books, with confidence that the orders have been made correctly and will be filled by the textbook source.

The above on-line system can help insure that an accurate bookstore list of books will be developed and maintained which can build a high degree of faculty and student confidence in the bookstore ordering process and inventory. It can also help assure that the correct used books will be purchased from students and whatever additional new books that may be needed will be ordered on time.

It should be understood that the above-referenced arrangements are illustrative of the application for the principles of the present invention. It will be apparent to those of ordinary skill in the art that numerous modifications can be made without departing from the principles and concepts of the invention as set forth in the claims.

What is claimed is:

1. A method for conducting a plurality of merchandising transactions with a customer of a bookstore relating to a printed book, comprising:
assigning a unique book number to the printed book;
affixing the unique book number to the printed book;
recording the unique book number in a database, linked to indicia related to the printed book; and
recording a transaction history related to the selected printed book in the database.

2. The method of claim 1, wherein the step of recording the unique book number in the database includes linking the unique book number to a customer.

3. The method of claim 1, wherein the step of affixing the book number to the selected printed book includes affixing a label to the printed book with a code thereon representative of the unique book number.

4. The method of claim 3, wherein the unique book number recording step includes electronically scanning the code on the label to enter the book number and indicia into the database.

5. The method of claim 1, wherein the transaction history recording step includes recording the sale of the printed book from the bookstore to the customer.

6. The method of claim 1, wherein the transaction recording step includes recording the purchase by the bookstore of the printed book from the customer.

7. The method of claim 1, wherein the step of recording the unique book number includes entering the unique book number in a database that is accessible by a plurality of bookstores.

8. A method of a bookstore buying a selected printed used book from a customer, comprising:
(a) recording certain indicia related to the selected printed used book in a database, wherein the indicia includes a unique book number for each selected printed used book;
(b) electronically searching a plurality of merchandising databases for comparison indicia similar to the indicia of the selected printed used book;
(c) determining a price relative to the comparison indicia; and
determining an optimum purchase price for the bookstore to pay to the customer for the selected printed used book.

9. The method of claim 8, further comprising electronically searching a bookstore database using the book number to find a record of prior transactions regarding the used book.

10. The method of claim 9, further comprising using the record of prior transactions in determining an optimum purchase price.

11. The method of claim 8, further comprising creating a record in a bookstore database associating the unique book number with information about the customer.

12. The method of claim 8, wherein the recording step includes recording a condition of the printed used book.

13. The method of claim 9, wherein the step of electronically searching further comprises scanning at least one database of an affiliated network of bookstores that buy and sell used printed books.

14. The method of claim 8 further comprising affixing a label to the selected printed book, the label having the unique book number thereon in one of a bar code and alpha-numerical configuration.

15. The method of claim 8, further comprising tracking subsequent transactions relative to the selected printed book, using the unique book number.

16. The method of claim 8, further comprising determining a channel for placement of the used book.

17. A method of conducting buying and selling transactions with a customer relative to a plurality of books involving a network of bookstores, comprising:
(a) recording customer information in a database to create a customer account in any bookstore in the network of bookstores;
(b) applying a unique book number to each of the plurality of books for use in tracking each book;
(b) establishing a credit amount in the account of the customer;
(c) providing access to the database having the customer account with the credit amount to all the bookstores in the network of bookstores; and
(d) enabling any bookstore in the network of bookstores to directly make changes in the credit amount relative to book transactions by the customer at said any bookstore.

18. The method of claim 17, wherein the establishing step comprises purchasing a book from the customer and crediting the account of the customer with the purchase price.

19. The method of claim 17, wherein the enabling step comprises enabling said each bookstore to record a purchase of a book from the customer as a credit to the customer account and to record a sale of a book to a customer as a debit to the customer account.

20. The method of claim 17, wherein the customer account is an entity account set up for an entity to buy and sell books for affiliated persons associated with the entity.

21. The method of claim 20, wherein the establishing step comprises receiving funds from the entity and crediting the entity account with the received funds.

22. The method of claim 20, wherein the enabling step comprises enabling any bookstore in the network to debit the entity account for a purchase of a book by a person affiliated with the entity and crediting the entity account for a sale of a book by a person affiliated with the entity.
